(19) United States
(12) Patent Application Publication
(10) Pub. No.: US 2010/0213811 A1
(43) Pub. Date: Aug. 26, 2010

(54) PACKAGE FOR LIGHT EMITTING ELEMENT AND METHOD FOR MANUFACTURING SAME

(75) Inventors: Takuma Hitomi, Osaka (JP); Masanori Hongo, Osaka (JP); Hideki Ito, Osaka (JP); Kiyoshi Yamakoshi, Osaka (JP); Masami Fukuyama, Osaka (JP); Hideki Takagi, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: SANYO ELECTRIC CO., LTD., Osaka (JP); SANYO TUNER INDUSTRIES CO., LTD., Osaka (JP)

(21) Appl. No.: 12/708,868

(22) Filed: Feb. 19, 2010

(30) Foreign Application Priority Data
Feb. 24, 2009 (JP) 2009-040493

(51) Int. Cl. H01J 1/88; C03B 29/00

(52) U.S. Cl. 313/113; 156/89.11

(57) ABSTRACT

The package for a light emitting element according to the present invention comprises a base substrate made of ceramic including glass, and a frame body made of ceramic. The frame body is arranged on a top surface of the base substrate and provided therein with a cavity for accommodating the light emitting element. A part of the glass included in the base substrate is precipitated in an area of the top surface of the base substrate, which is a bottom surface of the cavity, and a crystallinity degree of the precipitated glass is greater than 3%. In the manufacturing method of the package according to the present invention, a ceramic body which is to be the package is fired at a temperature of 840 degrees C. or higher and lower than 950 degrees C.

The application Number 2009-040493, upon which this patent application is based, is hereby incorporated by reference.

### BACKGROUND OF THE INVENTION

1. Field of the Invention

The present invention relates to a package for mounting a light emitting element thereon (a package for a light emitting element), and a method for manufacturing the package.

2. Description of Related Art

Conventionally, in a light emitting device shown in FIG. 9, used is a package 102 for mounting thereon a light emitting element 101. The package 102 comprises a base substrate 103 and a frame body 104 each made of ceramic and which are integrally bonded together. The frame body 104 has a cavity 104a defined therein for accommodating the light emitting element 101. A metal layer 105 made of silver (Ag), aluminum (Al) or the like is formed in an area of a top surface of the base substrate 103, which is a bottom surface of the cavity 104a. The light emitting element 101 is disposed in the cavity 104a at a position on the metal layer 105.

With the light emitting device described above, a light is emitted from the light emitting element 101 in all directions. The light upwardly emitted advances upward without change, while the light downwardly emitted is reflected on a surface of the metal layer 105 to advance upward, with a change of its advancing direction at the reflection.

However, in the light emitting device shown in FIG. 9, since the metal layer 105 is exposed to the top surface of the base substrate 103, the surface of the metal layer 105 could deteriorate due to oxidation to possibly reduce an optical reflectivity of the metal layer 105. Also, in the light emitting device having the cavity 104a filled with a resin 106 including a fluorescent material, as shown in FIG. 10, the surface of the metal layer 105 could deteriorate due to chemical reaction between the metal layer 105 and the resin 106 to possibly reduce the optical reflectivity of the metal layer 105. Therefore, in the conventional light emitting devices, a sufficiently high emission intensity cannot be obtained.

### SUMMARY OF THE INVENTION

In view of above described problem, an object of the present invention is to provide a package for a light emitting element which is capable of maintaining a sufficiently high emission intensity and a method for manufacturing the package.

A first package for a light emitting element according to the present invention comprises a base substrate made of ceramic including glass, and a frame body made of ceramic. The frame body is arranged on a top surface of the base substrate and provided therein with a cavity for accommodating the light emitting element. A part of the glass included in the base substrate is precipitated in an area of the top surface of the base substrate, which is a bottom surface of the cavity, and a crystallinity degree of the precipitated glass is greater than 3%.

With the package described above, since the crystallinity degree of the glass precipitated on the top surface of the base substrate is greater than 3%, a glass layer which has a small surface roughness is formed on the top surface of the base substrate compared to the case where the crystallinity degree is not greater than 3%. Therefore, a surface of the glass layer forms a light reflecting surface which has a sufficiently high optical reflectivity. Accordingly, in the case where the light emitting element is accommodated in the cavity, a light downwardly emitted from the light emitting element is reflected on the surface of the glass layer to advance upward. As a result, the sufficiently high emission intensity is obtained in the package with the cavity accommodating the light emitting element therein.

Also, on the glass layer formed by the precipitated glass, oxidation or chemical reaction which could cause deterioration with age hardly occurs, so that a decrease in the optical reflectivity due to deterioration with age hardly occurs.

A second package for a light emitting element according to the present invention is the first package for the light emitting element described above, wherein the base substrate is formed of a low temperature co-fired ceramic.

A third package for a light emitting element according to the present invention is the first or second package for the light emitting element described above, wherein the base substrate is formed by stacking a plurality of ceramic sheets made of ceramic including glass and firing the ceramic sheets stacked.

A first manufacturing method of a package for a light emitting element according to the present invention is a manufacturing method of a package for a light emitting element including a base substrate made of ceramic including glass, and a frame body made of ceramic. The frame body is arranged on a top surface of the base substrate and provided therein with a cavity for accommodating the light emitting element. The method comprises the steps of: forming a ceramic body by forming a first ceramic forming body which is to be the base substrate from the ceramic including glass and arranging a second ceramic forming body which is to be the frame body on a top surface of the first ceramic forming body; and firing the ceramic body at a temperature of 840 degrees C. or higher and lower than 950 degrees C.

By firing the ceramic body at a temperature of 840 degrees C. or higher and lower than 950 degrees C. in the firing step, the base substrate is formed from the first ceramic forming body, while the frame body provided therein with the cavity is formed from the second ceramic forming body, and the glass having a crystallinity degree of greater than 3% is precipitated in an area of the top surface of the base substrate, which is a bottom surface of the cavity.

If the ceramic body is fired at a temperature of lower than 840 degrees C., the crystallinity degree of the glass precipitated on the top surface of the base substrate is not greater than 3%. Therefore, when the ceramic body is fired at the temperature of 840 degrees C. or higher, the crystallinity degree of the glass is greater, and the glass layer with smaller surface roughness is formed on the top surface of the base substrate, resulting in a light reflecting surface having a sufficiently high optical reflectivity formed by the surface of the glass layer.

Accordingly, in the case where the light emitting element is accommodated in the cavity of the produced package, the light downwardly emitted from the light emitting element is reflected on the surface of the glass layer to advance upward. As a result, the sufficiently high emission intensity is obtained in the package with the cavity accommodating the light emitting element therein.

Also, on the glass layer formed by the precipitated glass, oxidation or chemical reaction which could cause deterioration with age hardly occurs, so that a decrease in the optical reflectivity due to deterioration with age hardly occurs.

A second manufacturing method of a package for a light emitting element according to the present invention is the first manufacturing method of the package for the light emitting element described above, wherein in the ceramic body forming step, the first ceramic forming body is formed of a low temperature co-fired ceramic.

A third manufacturing method of a package for a light emitting element according to the present invention is the first or second manufacturing method of the package for the light emitting element described above, wherein in the ceramic body forming step, the first ceramic forming body is formed by stacking a plurality of ceramic sheets made of ceramic including glass.

### BRIEF DESCRIPTION OF THE DRAWINGS

FIG. 1 is a cross-sectional view of a ceramic body to be used for manufacturing a light emitting device according to a first embodiment of the present invention;

FIG. 2 is a cross-sectional view of a package produced by firing the ceramic body;

FIG. 3 is a cross-sectional view of the package with the light emitting element installed therein;

FIG. 4 is a cross-sectional view of a produced light emitting device;

FIG. 5 is a view showing in a graph a relation between firing temperature and crystallinity degree of glass;

FIG. 6 is a view showing in graphs a relation between wavelength of an incident light and reflectivity of the light in the package;

FIG. 7 is a view showing in graphs regular reflection characteristics in the package;

FIG. 8 is a cross-sectional view of one modification example of the light emitting device;

FIG. 9 is a cross-sectional view showing an example of a conventional light emitting device; and

FIG. 10 is a cross-sectional view showing another example of the conventional light emitting device.

### DETAILED DESCRIPTION OF THE PREFERRED EMBODIMENT

A preferred embodiment of the present invention is described in detail below with reference to the drawings.

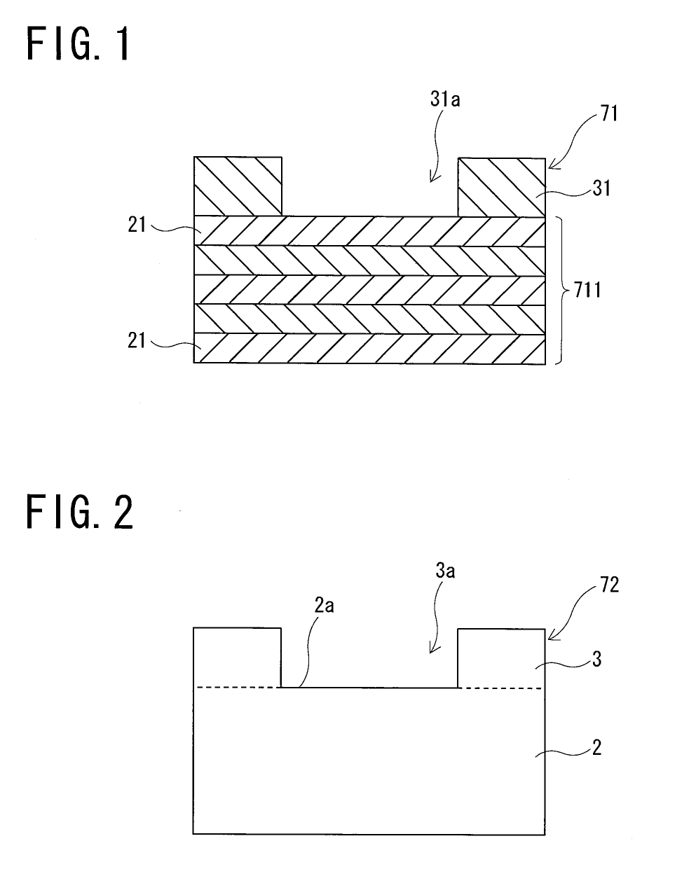

FIGS. 1 to 4 are cross-sectional views showing a manufacturing method of a light emitting device according to an embodiment of the present invention in the order of steps thereof.

First, in a ceramic body forming step, as shown in FIG. 1, by stacking a plurality of ceramic sheets 21 made of ceramic including glass, a stacked body 711 of the ceramic sheets 21 is formed.

After forming the stacked body 711, a frame forming body 31 made of ceramic including glass is disposed on a top surface of the stacked body 711. A ceramic body 71 is thereby formed by the stacked body 711 and the frame forming body 31. The frame forming body 31 can be formed by stacking a plurality of ceramic sheets in a similar way to the stacked body 711.

As ceramic including glass, employed is a low temperature co-fired ceramic (LTCC) which can be simultaneously fired with a metal such as silver (Ag), copper (Cu) or the like. In this embodiment, employed is a low temperature co-fired ceramic (LTCC) including alumina and glass with a ratio of 1:1.

Here, the metal such as silver (Ag), copper (Cu) or the like is, for example, filled in a thermal via (not shown) which enhances heat dissipation properties of the light emitting device and used as a thermally-conductive material.

Next, in a firing step, the ceramic body 71 formed in the ceramic body forming step is fired at a temperature of 840 degrees C. or higher and lower than 950 degrees C. Since the low temperature co-fired ceramic (LTCC) is used as the ceramic forming the ceramic body 71, the ceramic body 71 is sintered at a firing temperature of 840 degrees C. or higher and lower than 950 degrees C. A firing temperature of 840 degrees C. or higher and lower than 950 degrees C. allows the metal such as silver (Ag), copper (Cu) or the like which is used as the thermally-conductive material to be sintered while inhibiting abnormal contraction of the metal.

By firing the ceramic body 71, the stacked body 711 and the frame forming body 31 are sintered to form the base substrate 2 and a frame body 3 respectively, and a base substrate 2 and the frame body 3 are integrally bonded together as shown in FIG. 2. Also, due to sintering of the frame forming body 31, the space 31a (see FIG. 1) defined inside the frame forming body 31 becomes a cavity 3a for accommodating a light emitting element 1. Thus, produced is a package 72 for a light emitting element formed by the base substrate 2 and the frame body 3.

Further, by firing the ceramic body 71, on a surface of the package 72, a part of the glass included in the ceramic is precipitated and crystallized to form a glass layer (not shown). Therefore, the glass layer is formed also in an area of a top surface 2a of the base substrate 2, which is a bottom surface of the cavity 3a.

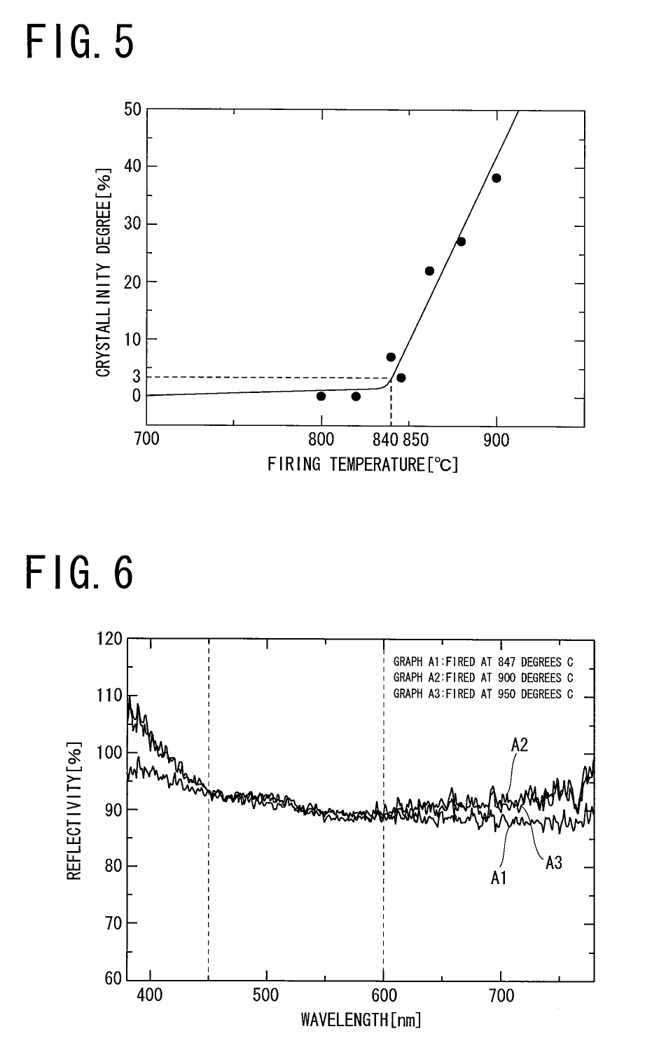

FIG. 5 is a view showing in a graph a relation between the firing temperature of the ceramic body 71 and crystallinity degree of the precipitated glass. As shown in FIG. 5, the higher the firing temperature is, the greater the crystallinity degree of the precipitated glass is. In the case where the firing temperature is 840 degrees C. or higher, the crystallinity degree of the precipitated glass is greater than 3%. Also, in the case where the firing temperature is around 900 degrees C., the crystallinity degree of the precipitated glass is around 40%. Further, in the case where the firing temperature is around 950 degrees C., the crystallinity degree of the precipitated glass is around 60% (not shown).

In contrast, in the case where the firing temperature is lower than 840 degrees C., the crystallinity degree of the precipitated glass is not greater than 3%. In a conventional package using the low temperature co-fired ceramic (LTCC), the firing is performed at a temperature of lower than 840 degrees C. Therefore, even if the glass is precipitated on the top surface 2a of the base substrate 2, the crystallinity degree thereof is not greater than 3%.

Accordingly, the firing of the ceramic body 71 at a temperature of 840 degrees C. or higher precipitates the glass having the crystallinity degree greater than 3% on the surface of the package 72. In this case, the crystallinity degree of the precipitated glass is great compared to the case where the ceramic body 71 is fired at a temperature of lower than 840 degrees C. However, it is not preferable to set the firing temperature too high. Details are described later.

FIG. 6 is a view showing in graphs A1 to A3 a relation between wavelength of an incident light and reflectivity of the light in each of the packages 72 which are produced at firing temperatures of 847 degrees C., 900 degrees C., and 950 degrees C. The graphs shown in FIG. 6 show that the high reflectivity of 85% or higher is obtained in the package 72 produced at a firing temperature of 847 degrees C. The graphs also show that, the packages 72 produced at a firing temperature higher than 847 degrees C. (900 degrees C. or 950 degrees C.) has an even higher reflectivity especially as to the lights having wavelengths of between 380 nm and 450 nm, and between 600 nm and 780 nm. The reflectivities of the packages 72 produced at 900 degrees C. and 950 degrees C. are rarely different.

As shown in FIG. 5, the crystallinity degree of the precipitated glass is around 3% when the firing temperature is 847 degrees C., around 40% when the firing temperature is 900 degrees C., and around 60% when the firing temperature is 950 degrees C.

Tables 1 and 2 show quantified reflectivities which the package 72 has as to the lights respectively having wavelengths of 405 nm and 650 nm shown in FIG. 6. As shown in Table 1, the reflectivity as to the light having a wavelength of 405 nm is 97% when the firing temperature is 847 degrees C., and 101.2% when the firing temperature is 900 degrees C. As shown in Table 2, the reflectivity as to the light having a wavelength of 650 nm is 89.8% when the firing temperature is 847 degrees C., and 91.8% when the firing temperature is 900 degrees C.

TABLE 1

| FIRING TEMPERATURE (DEGREES C.) | 847 | 900 |
|---|---|---|
| REFLECTIVITY (%) | 97 | 101.2 |

TABLE 2

| FIRING TEMPERATURE (DEGREES C.) | 847 | 900 |
|---|---|---|
| REFLECTIVITY (%) | 89.8 | 91.8 |

The graphs shown in FIG. 6 and data shown in Tables 1 and 2 show that when the crystallinity degree of the precipitated glass is higher than 3%, the reflectivity of light on the glass layer formed by the precipitated glass is sufficiently high, and therefore, the surface roughness of the glass layer is sufficiently small.

Accordingly, the surface roughness of the glass layer formed on the top surface 2a of the base substrate 2 in the package 72 produced at a firing temperature of 840 degrees C. or higher is smaller than that in the conventional package produced at a firing temperature of lower than 840 degrees C. As a result, a surface of the glass layer forms a light reflecting surface having a sufficiently high optical reflectivity, and the light downwardly emitted from the cavity 3a is reflected on the surface of the glass layer to advance upward.

On the glass layer formed by the precipitated glass, oxidation or chemical reaction which could cause deterioration with age hardly occurs, so that a decrease in the optical reflectivity due to deterioration with age hardly occurs.

As described above, in the case where the ceramic body 71 is fired at a temperature of 840 degrees C. or higher, the glass with a crystallinity degree of greater than 3% is precipitated on the surface of the package 72 to form the glass layer having a sufficiently high optical reflectivity. Accordingly, it is preferable that the firing temperature of the ceramic body 71 is 840 degrees C. or higher.

Further, the inventors of the present application have verified that it is preferable that the firing temperature of the ceramic body 71 is lower than 950 degrees C. through experiment.

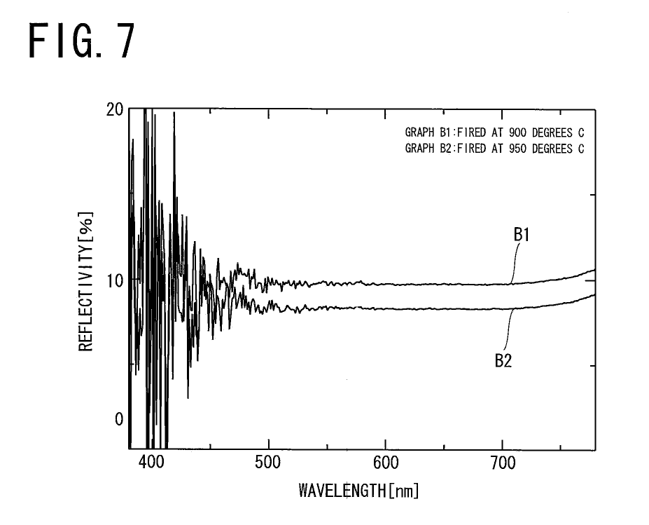

FIG. 7 is a view showing in graphs B1 and B2 regular reflection characteristics in the packages 72 produced at firing temperatures of 900 degrees C. and 950 degrees C. respectively. The graphs shown in FIG. 7 show that when the firing temperature increases to 950 degrees C., the regular reflection characteristics of the produced package 72 starts to decrease.

Therefore, it is preferable that the firing temperature of the ceramic body 71 is lower than 950 degrees C. in view of not only inhibition of abnormal contraction of the metal which is simultaneously fired with the ceramic body 71, but also inhibition of the decrease in the regular reflection characteristics of the package 72.

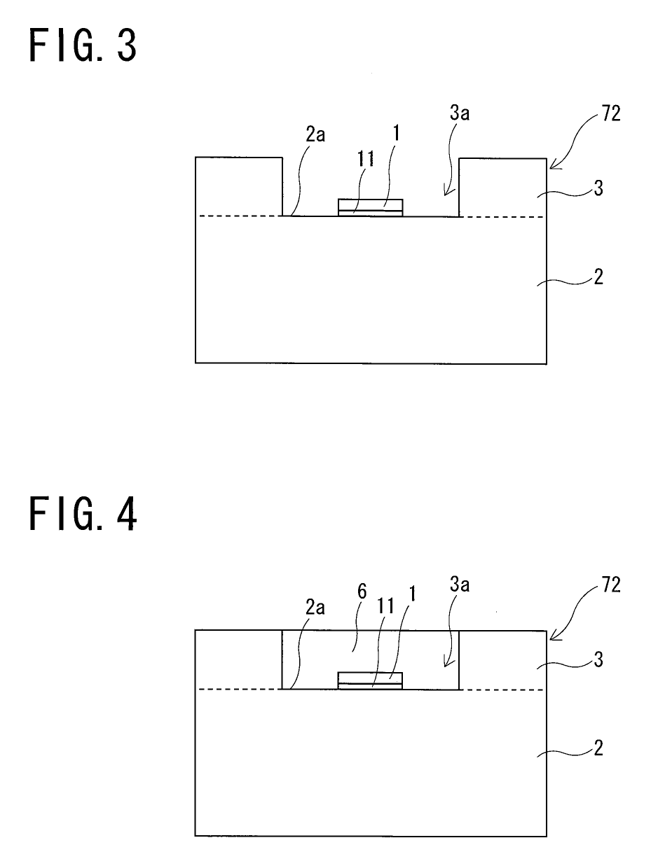

After executing the firing step, in a light emitting element installation step, as shown in FIG. 3, the light emitting element 1 is installed in the package 72 produced in the firing step. In particular, the light emitting element 1 is installed in the cavity 3a and on a die attach pad 11 disposed on the top surface 2a of the base substrate 2 where the glass layer is formed.

And then, in a resin filling step, as shown in FIG. 4, a resin 6 including a fluorescent material is filled in the cavity 3a, and the resin 6 is hardened. The light emitting device according to this embodiment of the present invention is thereby produced.

In the light emitting device thereby produced, the light downwardly emitted from the light emitting element 1 is reflected on the light reflecting surface formed by the surface of the glass layer to advance upward. As a result, the sufficiently high emission intensity is obtained in the light emitting device.

Since the surface of the glass layer hardly deteriorates as described above, maintained is a sufficiently high emission intensity of the light emitting device.

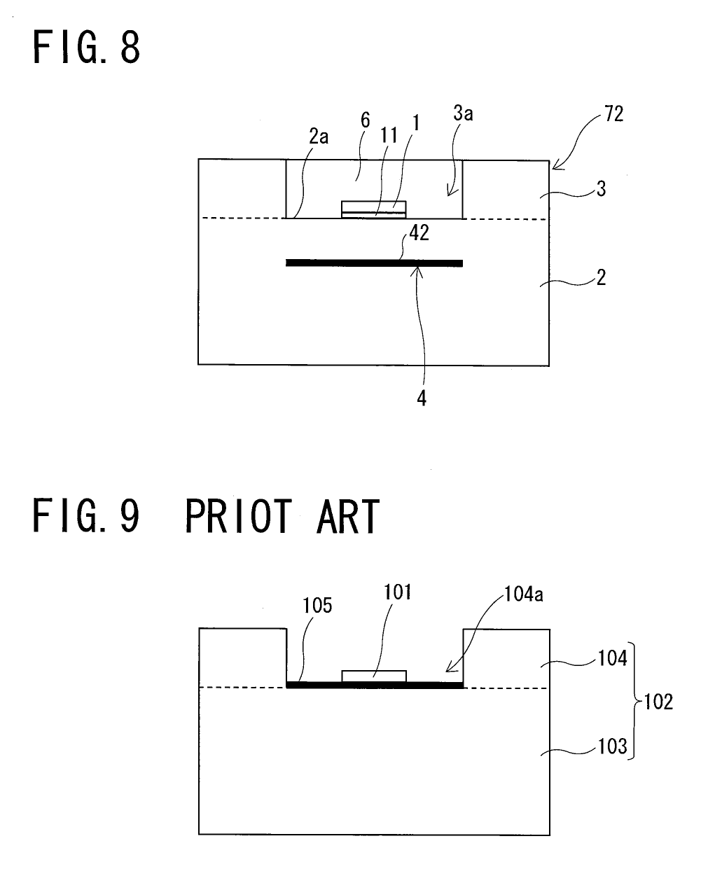

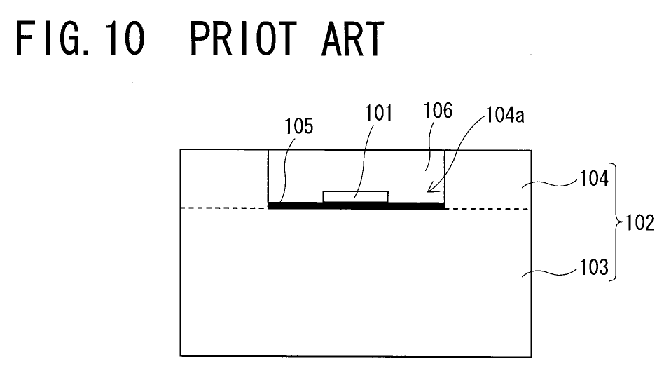

FIG. 8 is a cross-sectional view of one modification example of the light emitting device described above. As shown in FIG. 8, a light reflecting plate 4 can be buried in the base substrate 2 of the package 72 at a position below the light emitting element 1 with a light reflecting surface 42 of the light reflecting plate 4 facing upward.

For the light reflecting plate 4, employed is a metal such as silver (Ag), aluminum (Al) or the like which can exhibit a high optical reflectivity.

In the package 72 shown in FIG. 8, a part of the low temperature co-fired ceramic (LTCC) forming the base substrate 2 is interposed between the light reflecting surface 42 of the light reflecting plate 4 and the top surface 2a of the base substrate 2. However, since the low temperature co-fired ceramic is light-transmitting, in the case where a part of the light downwardly emitted from the light emitting element 1 accommodated in the cavity 3a goes through the glass layer, the light which goes through the glass layer reaches the light reflecting surface 42 of the light reflecting plate 4, and is reflected on the light reflecting surface 42 to advance upward.

Therefore, the light downwardly emitted from the light emitting element 1 is upwardly guided efficiently, and maintained is a higher emission intensity of the light emitting device according to the modification example.

The present invention is not limited to the foregoing embodiments in construction but can be modified variously within the technical range set forth in the appended claims. In the embodiment described above, the low temperature co-fired ceramic (LTCC) including alumina and glass with a ratio of 1:1 is employed as the ceramic forming the base substrate 2. However, the present invention is not limited to this and a variety of low temperature co-fired ceramics may be employed.

What is claimed is:

1. A package for a light emitting element comprising a base substrate made of ceramic including glass, and a frame body made of ceramic, the frame body being arranged on a top surface of the base substrate and provided therein with a cavity for accommodating the light emitting element,
wherein a part of the glass included in the base substrate is precipitated in an area of the top surface of the base substrate, which is a bottom surface of the cavity, and a crystallinity degree of the precipitated glass is greater than 3%.

2. The package for the light emitting element according to claim 1, wherein the base substrate is formed of a low temperature co-fired ceramic.

3. The package for the light emitting element according to claim 1, wherein the base substrate is formed by stacking a plurality of ceramic sheets made of ceramic including glass and firing the ceramic sheets stacked.

4. A manufacturing method of a package for a light emitting element including a base substrate made of ceramic including glass, and a frame body made of ceramic, the frame body being arranged on a top surface of the base substrate and provided therein with a cavity for accommodating the light emitting element, the method comprising the steps of:
forming a ceramic body by forming a first ceramic forming body which is to be the base substrate from the ceramic including glass and arranging a second ceramic forming body which is to be the frame body on a top surface of the first ceramic forming body; and
firing the ceramic body at a temperature of 840 degrees C. or higher and lower than 950 degrees C.
